(19) United States
(12) Patent Application Publication
(10) Pub. No.: US 2009/0002135 A1
(43) Pub. Date: Jan. 1, 2009

(54) Control System

(76) Inventors: Franz Dold, Furtwangen (DE); Patrick Bornstein, Freiburg (DE); Klaus Weddingfeld, Waldkirch (DE); Oliver Koepcke, Neuenburg (DE)

Correspondence Address: THE NATH LAW GROUP, 112 South West Street, Alexandria, VA, 22314, US

(21) Appl. No.: 12/213,384

(22) Filed: Jun. 18, 2008

(30) Foreign Application Priority Data
Jun. 26, 2007 (DE) 102007029423.0

(51) Int. Cl. H04Q 5/22

(52) U.S. Cl. 340/10.51

(57) ABSTRACT

The invention relates to a control system, in particular to a safety control system, comprising at least one sensor, at least one control module for the reading out of the at least one sensor and for the generation of a control signal, wherein the at least one control module has at least one connection for a cable which can be connected to the control module. The control system in accordance with the invention furthermore has a data memory module which is mechanically connected to the cable to be connected to the connection and a data memory unit for the storage of configuration data of the control. A communications path is provided for the transfer of configuration data between the at east one control module and the at least one data memory module, wherein the cable is not provided, or is not only provided, for the data transfer between the data memory unit of the at least one data memory module and the at least one control module. The invention additionally relates to a method for the storage of configuration data of a control module, in particular of a safety control system.

The invention relates to a control system, in particular to a safety control system, having at least one sensor and at least one control module for the reading out of the at least one sensor and for the generation of a control signal.

Safety controls are used, for example, when warning signals or actuator signals should be generated in dependence on sensor signals. A non-allowed or unauthorized intervention into the danger zone of a machine can, for example, be detected by a sensor and can be communicated to a control. The control thereupon generates a warning signal or an actuator signal which results, for example, in the immediate stopping of the machine. Corresponding sensors can be formed, for example, by light barriers or light grids.

The control module necessary for this has to be configured correspondingly and the configuration data have to be stored.

In known solutions, for example, the configuration data, program data and diagnostic data of the control module are stored in a memory card which is typically plugged into a mechanical slot of the control module. The user prepares his desired configuration profile by means of a programming tool of a personal computer. The data are then either transferred to the control module via a programming interface and stored on the memory card. Alternatively, the data can be transferred by means of the personal computer to a memory card reader/writer in which the memory card is located. The user can then plug the memory card into the control module. The executable program of the control and the configuration of the input/output assemblies can be changed by a simple replacement of the memory card.

The portability of the memory card in particular entails a safety risk for safety applications due to the simple manipulation or to intentional or unintentional swapping. Mixing up two cards can result in reading the wrong configuration into the control module, whereby the system may possibly not work correctly or safety-critical situations and a hazard to the health of operators may even occur.

DE 198 39 564 A1 describes a portable memory unit which is not used for safety applications, but rather for the configuration of a barcode reader.

With a sensor unit of DE 202 15 631 U1, an individual sensor can be adapted to different demands and configured accordingly by replacing the input/output module. The input/output module includes the evaluation unit for this purpose. The total input/output installation assembly therefore has to be replaced for different configurations.

DE 198 31 493 C2 shows an optoelectronic sensor whose operation can be changed or expanded by a corresponding sensor expansion module in a housing attachment, which can be connected to a plug connection of the sensor, for which purpose, for example, an additional evaluation unit can be provided in a sensor expansion module.

An electric plug is known from DE 10 2005 049 483 A1 for the external storage of parameters of a sensor. A sensor is described having an integrated microcontroller, with the sensor having a plug connection for connection to an interface of the sensor. The plug has an electronic circuit which has a memory for the storage of parameter data and characteristics of the sensor.

It is the object of the present invention to provide a control system, in particular a safety control system, wherein the configuration data can be stored in a manner as secure against manipulation and as cost effective as possible and which nevertheless has great flexibility in the swapping of the control.

This object is satisfied by a control system having the features of claim 1 and by a method for the storage of configuration data of a control module having the features of claim 23. Preferred aspects are the subject of dependent claims.

The control system in accordance with the invention has a sensor and at least one control module for the reading out of the at least one sensor. The control module additionally serves for the generation of a control signal. The control module has a connection for a cable so that the control module can be connected to a cable of the control system. At least one data memory module is mechanically connected to the cable and has a data memory unit for the storage of configuration data of the control module. A communications path is provided for the transfer of the configuration data between the control module and the data memory unit. The cable with which the data memory module is mechanically connected does not serve, or does not exclusively serve, for the transfer of the configuration data of the control module. The cable and the communications path do not therefore correspond to one another, or at least not completely.

The fixed connection of the data memory module to the cable can take place, for example, by a screw connection or an adhesive bond. A preferred aspect provides for the data memory module to have a first connection with which it is connected to the cable. The data memory module advantageously has a second connection in this case with which it can be connected to the control module and indeed in a manner such that the electrical or electronic connection between the cable and the control module is established via the data memory module such that, in dependence on the original purpose or function of the cable, for example, data can be transferred to the control module via the cable or the power supply of the control module is ensured via the cable. The data memory module is then fixedly connected to a cable of the control module. The function of the cable, for example data transfer to the control module or power supply of the control module, is therefore “switched through” the data memory module in such an embodiment so that the data memory module does not disturb the original function of the cable.

If the control module is replaced, it is first always necessary to remove or unplug the cable together with the data memory module. The wiring must be interrupted to replace the data memory module. An unauthorized or unintentional change to the configuration is only possible with a fairly large effort and is easy to recognize. Nevertheless, the control module can be replaced simply, for example on a defect, with the configuration being maintained in the data memory module.

With such an embodiment, in which the data memory module has a second connection, this second connection can also include the communications path for the transfer of the configuration data between the control module and the data memory unit. In such a case, the second connection therefore, on the one hand, serves for the switching through of the function provided by the cable (for example, data communication or power supply) and, on the other hand, for the provision of a communications path between the data memory unit and the control module.

A secure embodiment, for example, provides that the first connection of the data memory module includes one or more screw connections for the connection to the cable. For example, to replace the data memory module in an unauthorized manner, the screw connections must first be released, which would at least take up a certain time.

Provision is made in a further embodiment for the data memory module not to be provided at the end of the cable. In this embodiment, the data memory module is connected between the cable and a further connection cable which serves for the connection to the control module. In this way, the data memory module does not have to be located in direct proximity to the control module so that the arrangement is less clear for a manipulator without authorization.

The control module of the control system in accordance with the invention serves for the reading out of sensor data and for the generation of a control signal. The control signal can, for example, be a warning signal which causes an operator to intervene in the operation of a system controlled by the control system. A particularly advantageous embodiment provides for the control module itself to be configured for the provision of actuator control signals. Such an actuator control signal can in particular serve for the stopping of a system controlled by the control system. Accordingly, the term “actuator control signal” is also used for a stop signal in the present text.

In an embodiment of the control system in accordance with the invention in which the control module also serves for the provision of actuator control signals, the cable to which the data memory module is connected can also serve for the electrical or electronic connection of the control module to at least one actuator so that, for example, the actuator can be addressed by the control module.

In other embodiments, the cable to which the data memory module is connected can serve for the electrical or electronic connection of the control module to at least one sensor so that, for example, the sensor can be read out by the control module via the cable.

A particularly preferred embodiment provides that the cable to which the data memory module is connected includes a supply cable, preferably a device power supply line for the power supply of the control module.

Such an embodiment is advantageous since the device power supply line is absolutely necessary for the operation of the control module. It is thus ensured that the data memory module which is connected to the device power supply line also remains in the system on a replacement of the control module.

The configuration data of the control module can in particular be transferred, for example, via a data interface by means of a personal computer to the control module and can then be transmitted from this into the data control unit of the data memory module.

As described, the configuration data can be exchanged between the control module and the data memory module via the second connection. An advantageous embodiment, on the other hand, provides that the communications path between the data memory module and the control module includes a radio transmission device in the data memory module, said radio transmission device being able to communicate with a corresponding radio transmission device in the control module in order to be able to exchange configuration data in a simple manner between the control module and the data memory module. Such a radio connection simplifies the connection geometry of the second connection which then does not serve as a communications path and reduces the error susceptibility, for example due to cable damage.

A radio transmission device can also be provided for the reception of configuration data from the at least one sensor and/or for the sending of configuration data to the at least one sensor. A radio transmission device can accordingly also be provided for the communication of the configuration data from an actuator and to an actuator.

It is particularly advantageous if both the configuration data of the control module and the configuration data of the at least one sensor and of any optionally present actuator, can communicate with the at least one data memory module with the help of a radio transmission device.

A simple embodiment provides that the data memory module has an RFID (radio frequency identification) tag for the data communication which permits transmission according to the principle of transponder technology.

The cable which can be connected to the control module and is connected to the data memory module can also include a data communication line which serves for the exchange of data from external devices or evaluation units with the control module.

In such an embodiment, the data memory module can simultaneously serve for the fixing of addresses which should be addressed by the data communication line. For this purpose, in an advantageous embodiment, an input possibility for address settings is provided at the data memory module. The input possibility can, for example, include one or more push buttons or can be formed by DIP (dual inline package) switches such as are used on boards or other circuit boards to carry out specific basic settings.

The data memory unit of a data memory module of a control system in accordance with the invention can, for example, be a flash memory or an EEPROM (electrically erasable programmable read only memory).

A particular advantage of the control system in accordance with the invention is shown when it is arranged in a switch cabinet. The special security of such a system is additionally increased in this connection since a replacement of the data memory module requires an interruption or a replacement of the wiring of the switch cabinet.

A particularly advantageous further development of the control system in accordance with the invention provides that not only the configuration data of the control module, but also configuration data from the at least one sensor and any optionally present actuators can be stored in the data memory module.

The invention furthermore relates to a method for the storage of configuration data of a control module, in particular of a control module of a safety control, having the features of claim 23. In the method in accordance with the invention, the configuration data of the control module are stored in a data memory unit of a data memory module which is mechanically connected to a cable of the control module, with the cable not being provided, or not exclusively being provided, for the transmission of the memory content of the data memory unit between the data memory module and the control module. The advantages of such a method result in an analog manner from the above description of the advantages of a control system in accordance with the invention. Special embodiments of the method in accordance with the invention equally result in an analog manner in accordance with the special embodiments of the control system in accordance with the invention described above.

Provision can be made both with the control system in accordance with the invention and with the method in accordance with the invention that the configuration data of the control module are stored on a further memory unit within the control module itself in addition to their storage in the data memory unit of the data memory module.

The invention will be explained with reference to the enclosed Figures in detail which schematically show exemplary embodiments in accordance with the invention. There are shown:

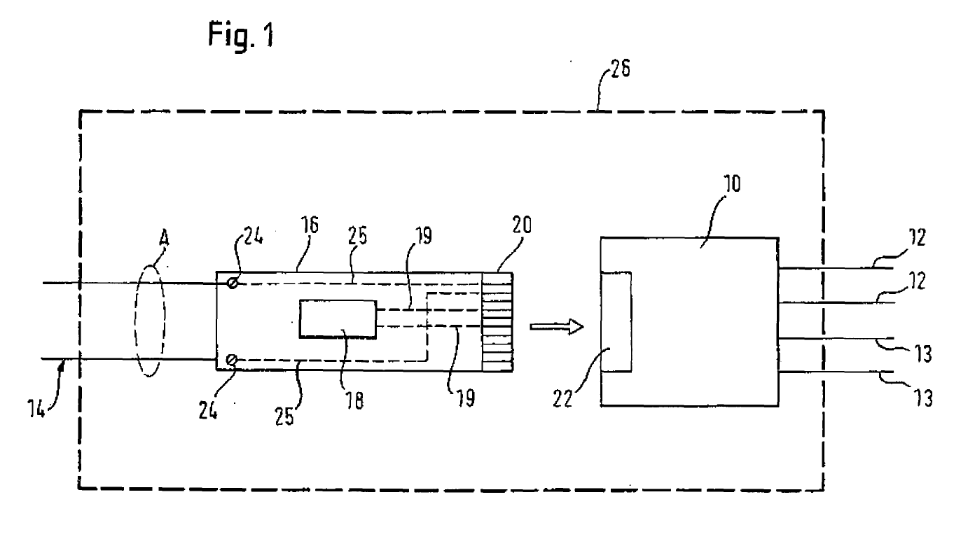

FIG. 1 an arrangement of an embodiment of a control system in accordance with the invention;

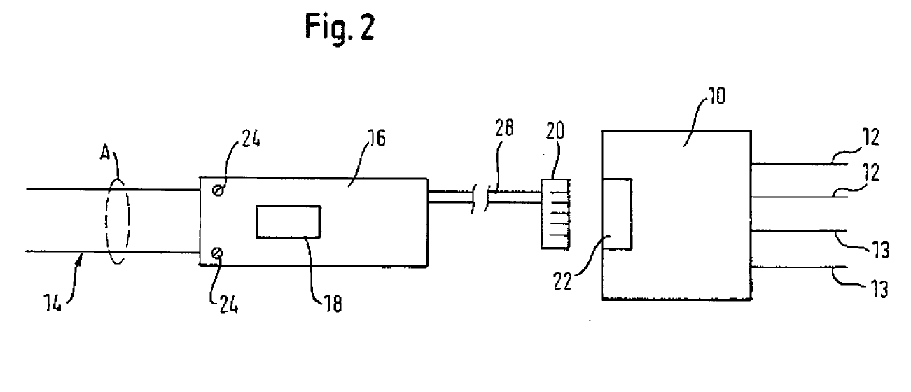

FIG. 2 another embodiment of a control system in accordance with the invention;

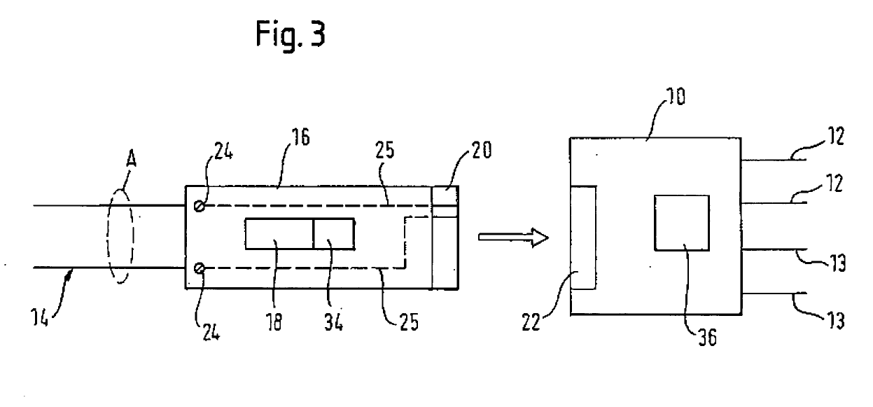

FIG. 3 a third embodiment of a control system in accordance with the invention;

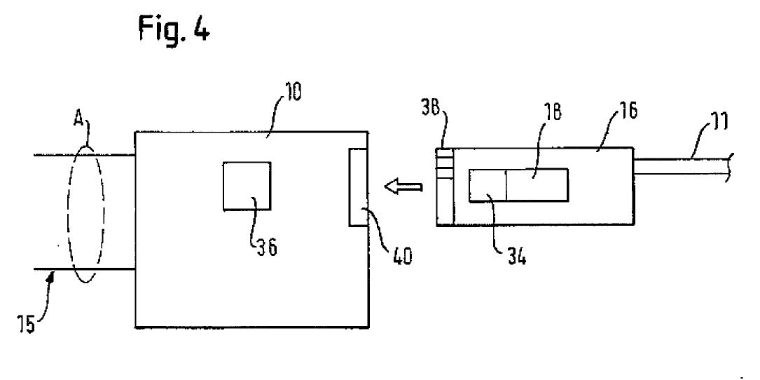

FIG. 4 a fourth embodiment of a control system in accordance with the invention; and

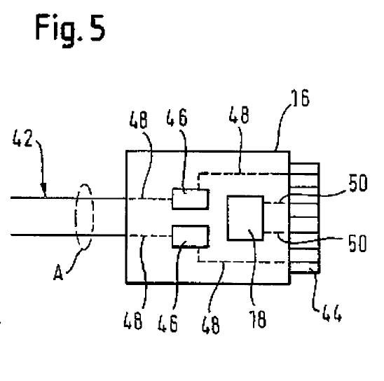

FIG. 5 the data memory module of a further embodiment.

FIG. 1 shows a control module 10 with connections 12 for sensors and connections 13 for actuators. In a manner not shown, sensors are connected to the connections 12 which, for example, monitor a danger zone of a machine, for example of a press. Signals of these sensors reach the control module 10 and are evaluated there in order to generate control signals as required which are output, for example, via control lines 13 to corresponding actuators which are likewise not shown.

In this embodiment, the connection 14 serves for the connection to a device power supply. The dashed line A is intended to indicate that, for example, a plurality of wires are combined to form a cable 14. The device power supply line 14 is connected via screw connections 24 to corresponding connection terminals of the data memory module 16. Reference numeral 16 designates a data memory module for the storage of configuration data of the control module 10. For this purpose, the data memory module 16 has a data memory unit 18, for example a flash memory or an EEPROM memory. The data memory module 16 has a connection plug 20 which can be plugged into a socket 22 of the control module 10 in the direction of the arrow. In this embodiment, the connections of the device power supply 14 are connected within the data memory module 16 to corresponding pins of the connection plug 20 to enable a power supply of the control module 10 with a data memory module 16 plugged into the control module 10. This is indicated by the internal connections 25 shown in dashed form.

The data memory unit 18 is connected via internal connections 19 shown in dashed form to other pins of the connection plug 20 to enable data communication with the control module 10.

The total control system with the control module 10 and the data memory module 16 is located in a schematically shown switch cabinet 26 in the example shown.

This embodiment can be used as follows. In operation, the data memory module 16 with the connection plug 20 is coupled to the socket 22. The control module obtains its operating power in this manner via the plug/socket combination 20/22 through the data memory module from the device power line 14.

Configuration data of the control module can, for example, be transmitted via a data interface, not shown, by means of a personal computer to the control module 10 and then stored by it in the data memory unit 18 of the connected data memory module 16. The writing of configuration data to the data memory unit 18 of the data memory module 16 can be protected, for example, by a suitable access protection by means of a password or of other higher grade manipulation protection mechanisms. During operation, diagnostic data which arise, such as errors or system statuses, can, for example, be stored in the data memory unit 18 of the data memory module 16.

If the control system of this embodiment in accordance with the invention is used, for example, for the securing of the danger zone of a machine, the sensor connections 12 are connected to corresponding sensors, for example light barriers. If a non-permitted object, for example a body part of an operator, enters into the danger zone, this is detected by a correspondingly arranged light barrier in a manner known per se and is reported to the control module 10 via the sensor connections 12. The control module 10 generates a corresponding actuator signal which is output via the actuator outputs 13 of the control module 10 to the machine to cause it to stop immediately, for example.

In the event of a defect of the control module 10, in the embodiment in accordance with the invention, only the switch cabinet 26 has to be opened and the control module removed. The configuration data remain stored on the data memory unit 18 of the data memory module 16 and can continue to be used directly by connection of the connection plug 20 to a new control module 10.

An unintentional or intentional, but unauthorized, replacement of the configuration data by replacement of the data memory module 16 is, however, made more difficult. After the opening of the switch cabinet 26, the connection between the data memory module 16 and the control module 10 would have to be separated for this purpose, whereby the power supply of the control module 10 would already be interrupted. A corresponding interruption of the power supply can be indicated by a corresponding warning signal. In addition, the screw connections 24 would have to be released which connect the data memory module 16 to the device power supply line 14. A greater effort to replace the data memory module 16 results overall, whereby an unauthorized replacement is made more difficult. An accidental mixing up of the data memory module 16 on the replacement of the control module 10 is impossible since the data memory module 16 is fixedly connected to the power supply of the control module 10.

FIG. 2 shows a modified embodiment. Here, a connection cable 28 in which lines for the power supply and for the data transmission are combined is located between the connection plug 20 for the connection of data memory module 16 and the control module 10. The internal connections of the data memory module are not shown here for reasons of clarity. The data memory module 16 in this embodiment does not have to be arranged in the direct vicinity of the control module 10. In particular an unauthorized swapping of the data memory module 16 is made more difficult in this manner since the individual components first have to be localized.

FIG. 3 shows an embodiment in which the data memory module 16 has a radio transmission interface 34, for example an RFID tag. A corresponding radio transmission interface 36 is provided in the control module 10. The connection plug 20 here only includes pins via which the device power supply line 14 can be connected via internal lines 25 to the socket 22 of the control module 10. The data transmission between the control module 10 and the data memory unit 18, in contrast, takes place via the radio transmission interfaces 34, 36, which act as transponders. Such an embodiment enables the reduction of the required number of cost-intensive plug contacts by the utilization of radio transmission interfaces.

FIG. 4 shows an embodiment in which the data storage module 16 is fixedly connected to a sensor connection cable 11. In the embodiment shown, data which are delivered via the sensor cable 11 from a sensor, not shown, are delivered by the data memory module 16 via connections, not shown, to the pins of the connection plug 38 which forwards them via the socket 40 to the control module 10. The power supply of the control module takes place via the device power supply line 15. Configuration data of the control module 10 are stored, as described in the embodiments of FIGS. 1 to 3, in the data memory unit 18 of the data memory module 16. The transfer of the configuration data from the data memory unit 18 to the control module 10 and vice versa takes place via the radio transmission interfaces 34, 36 in the embodiment shown, as has already been described for the embodiment of FIG. 3. In addition, configuration data of the sensor which is connected to the sensor connection 11 can be stored in the data memory unit 18 of the data memory module 16. In an embodiment, not shown, the data memory module 16 is not located in a sensor connection line 11, but rather in an actuator connection line, with the function being analog.

In this respect, the ideal evaluations and technical data can already be stored in the data memory unit 18 in the manufacture of the connected sensors or actuators. On the putting into operation of the sensor or actuator at the control module, these data can be transferred directly to the control module 10. The use of radio interfaces for the communication of the configuration data of the control module 10 proves to be particularly advantageous in such an embodiment since the data transfer protocols known per se for the sensor data can continue to be used which are used for the transfer of the sensor data from the sensor connection line 11 to the control module 10 and can further be carried out via the plug connection of the connection plug 38 and of the socket 40.

A detail of a further embodiment is shown in FIG. 5. The data memory module 16 with the data memory unit 18 is here fixedly connected mechanically to a communication connection 42. The communication connection 42, for example, serves for the data transmission from a sensor to a control module such as is also explained in the embodiment of FIG. 4. However, it can also be another communication connection to another peripheral.

Internal connections to the data lines 42, on the one hand (dashed lines 48), and internal connections to the data memory unit 18, on the other hand (dashed lines 50), are applied to the pins of the connection plug 44 in this embodiment. 46 designates addressing push buttons with which it is possible in a manner known per se to associate corresponding addresses to the data transmitted via the data lines 42, 46. In this embodiment, the data memory unit 16 is therefore not only used for the storage of the configuration data of the control module 10, not shown here, but rather, in an extension of the function, also for the addressing of the data lines 42. Provision can also be made here, deviating from the representation in FIG. 5, that the data transfer between the data memory unit 18 and the control module is carried out with the help of radio interfaces such as are described for the embodiments of FIGS. 3 and 4.

In the same way as is shown by way of example for the embodiment of FIG. 1, the control modules 10 and the data memory modules 16 of the embodiments of FIGS. 2 to 5 are also advantageously located in a switch cabinet.

In an embodiment which is not shown, the data memory module is only outwardly mechanically fastened to the cable, that is, for example, to the device power supply line 14 or to a data communication line 42 without this cable leading into the data memory module. The fastening can take place, for example, by an adhesive bonding or screwing to a terminal. The transmission of the configuration data between the data memory unit of the data memory module and the control module then takes place via radio interfaces or a separate plug connection.

### REFERENCE NUMERAL LIST

10 control module
11, 12 sensor connection
13 actuator connection
14, 15 device power line
16 data memory module
18 data memory unit
19 internal connection
20 connection plug
22 socket
24 screw connection
25 internal connection
26 switch cabinet
28 connection cable
34, 36 radio transmission interface
38 connection plug
40 socket
42 communication line
44 connection plug
46 addressing push button
48, 50 internal connection
A indication of the combination of wires to a cable

1. A control system, in particular a safety control system, comprising
at least one sensor;
at least one control module (10) for the reading out of the at least one sensor and for the generation of a control signal, wherein the at least one control module (10) has at least one connection (22, 40) for a cable (11, 14, 42);
at least one cable (11, 14, 42) releasably connectable to the control module (10);
at least one data memory module (16) which is mechanically connected to the cable (11, 14, 42) to be connected to the connection (22, 40) and includes a data memory unit (18) for the storage of configuration data of the at least one control module (10); and
a communications path (34, 36) for the transfer of configuration data between the at least one control module (10) and the at least one data memory module (16),
wherein the cable (11, 14, 42) is not provided, or is not only provided, for the data transfer between the data memory unit (18) of the at least one data memory module (16) and the at least one control module (10).

2. A control system in accordance with claim 1, wherein the data memory module (16) includes a first connection (24) for the connection to the cable (14).

3. A control system in accordance with claim 2, wherein the first connection (24) is made non-releasable.

4. A control system in accordance with claim 2, wherein the data memory module (16) includes a second connection (20, 38, 44) for connection to the control module (10) such that the electrical or electronic connection between the cable (11, 14, 42) and the control module (10) is established via the data memory module (16).

5. A control system in accordance with claim 4, wherein the second connection (20, 38, 44) includes the communications path.

6. A control system in accordance with claim 4, wherein the first connection includes one or more screw connections (24) and/or the second connection (20, 38, 44) includes one or more plug connections.

7. A control system in accordance with claim 4, wherein the second connection (20) includes at least one connection cable (28) which is configured such that the data memory module (16) connected to the control module (10) can be provided remote from the control module (10).

8. A control system in accordance with claim 1, wherein the control module (10) is configured for the provision of actuator signals.

9. A control system in accordance with claim 8, wherein the cable (11) serves for the connection of the control module (10) to at least one actuator.

10. A control system in accordance with claim 1, wherein the cable (11) serves for the connection of the control module (10) to at least one sensor.

11. A control system in accordance with claim 1, wherein the cable includes a supply cable (14), preferably a device power supply line, for the power supply of the control module (10).

12. A control system in accordance with claim 1, wherein the communications path includes a radio transmission device (34) in the data memory module (16) for the reception of configuration data from the control module (10) and/or for the sending of configuration data to a radio transmission device (36) of the control module (10).

13. A control system in accordance with claim 1, wherein the at least one data memory unit (18) is configured for the storage of configuration data of further connected devices, in particular of sensors and/or actuators.

14. A control system in accordance with claim 13, wherein the data memory module (16) includes a radio transmission device for the reception of configuration data from the at least one sensor and/or for the sending of configuration data to the at least one sensor.

15. A control system in accordance with claim 13, wherein the data memory module (16) includes a radio transmission device for the reception of configuration data from at least one actuator and/or for the sending of configuration data to at least one actuator.

16. A control system in accordance with claim 12, wherein the data memory module (16) includes an RFID tag for radio transmission.

17. A control system in accordance with claim 14, wherein the data memory module (16) includes an RFID tag for radio transmission.

18. A control system in accordance with claim 15, wherein the data memory module (16) includes an RFID tag for radio transmission.

19. A control system in accordance with claim 1, wherein the cable includes a data communication line (42).

20. A control system in accordance with claim 19, wherein the data memory module (16) includes at least one input possibility (46), in particular for address settings.

21. A control system in accordance with claim 20, wherein the input possibility includes one or more push buttons (46) and/or DIP switches.

22. A control system in accordance with claim 1, wherein the data memory unit (18) includes a flash memory or an EEPROM memory.

23. A control system in accordance with claim 1, wherein the control module (10) is located in a switch cabinet (26).

24. A control system in accordance with claim 1, wherein the control module (10) is configured for the generation of a control signal which includes an actuator signal, in particular a stop signal, and/or a warning signal.

25. A method for the storage of configuration data of a control module (10) using a control system comprising
at least one sensor;
at least one control module (10) for the reading out of the at least one sensor and for the generation of a control signal, wherein the at least one control module (10) has at least one connection (22, 40) for a cable (11, 14, 42);
at least one cable (11, 14, 42) releasably connectable to the control module (10);
at least one data memory module (16) which is mechanically connected to the cable (11, 14, 42) to be connected to the connection (22, 40) and includes a data memory unit (18) for the storage of configuration data of the at least one control module (10); and
a communications path (34, 36) for the transfer of configuration data between the at least one control module (10) and the at least one data memory module (16),
wherein the cable (11, 14, 42) is not provided, or is not only provided, for the data transfer between the data memory unit (18) of the at least one data memory module (16) and the at least one control module (10),
the method comprising the storage of the configuration data of the control module (10) in the data memory unit (18) of the data memory module (16) which is mechanically connected to the cable (11, 14, 42) for connection to the control module (10) which is not used, or is not only used, for the data transfer between the data memory unit (18) of the data memory module (16) and the control module.
